(19) United States
(12) Patent Application Publication
(10) Pub. No.: US 2006/0179698 A1
(43) Pub. Date: Aug. 17, 2006

(54) Signage and method of making the same

(76) Inventor: Herman Poulin, St. Paul (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/301,459

(22) Filed: Dec. 13, 2005

(30) Foreign Application Priority Data
Jan. 24, 2005 (CA) 2,494,303

(51) Int. Cl. G09F 7/02

(52) U.S. Cl. 40/618

(57) ABSTRACT

A method of forming signage. A first step involves providing an inventory of discrete alpha-numeric elements, graphic symbols and spacer elements. Each of the alpha-numeric elements displays a single alpha-numeric character. The inventory includes alpha-numeric elements displaying all 26 letters and numbers 0 through 9. A second step involves selecting from the inventory alpha-numeric elements necessary to display a desired message, together with such spacer elements as may be required to hold places between alpha-numeric elements in order to form word or number grouping in the alpha-numeric message. A third step involves arranging the selected alpha-numeric elements and spacer elements in a desired order to display the desired message.

This application claims priority from Canadian Application Serial No. 2,494,303 filed Jan. 24, 2005.

### FIELD OF THE INVENTION

The present invention relates to signage that uses alpha-numeric characters or graphic symbols to display a building address, a business name, or an advertising message.

### BACKGROUND OF THE INVENTION

It is expensive to custom make signage to display business addresses, business names or advertising messages. U.S. Pat. No. 5,560,173 (Scheiwiller 1996) provides one alternative using a plurality of concrete or composite elements in the form of landscaping stones or thin composite tiles. A plurality of elements can be laid out to form any alpha-numeric character on a floor or wall.

### SUMMARY OF THE INVENTION

According to one aspect of the present invention there is provided a method of making signage. A first step involves providing an inventory of discrete alpha-numeric elements, graphic symbols and spacer elements. Each of the alpha-numeric elements displays a single alpha-numeric character. The inventory includes alpha-numeric elements displaying all 26 letters and numbers 0 through 9. A second step involves selecting from the inventory alpha-numeric elements and graphic symbols, those necessary to display a desired message, together with such spacer elements as may be required to hold places between alpha-numeric elements in order to form word or number grouping in the alpha-numeric message. A third step involves arranging the selected alpha-numeric elements, graphic symbols and spacer elements in a desired order to display the desired message.

The above described method provides a very flexible system for forming signage. There will hereinafter be described a preferred form of alpha-numeric element, along with a signage assembly formed in accordance with the teachings of the present invention.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a front elevation view of a signage assembly constructed in accordance with the teachings of the present method.

FIG. 2 is a perspective view of an alpha-numeric tile element displaying a letter, which can be used to form the signage assembly illustrated in FIG. 1.

FIG. 3 is a perspective view of an alpha-numeric element displaying a number, from the signage assembly illustrated in FIG. 1.

FIG. 4 is a perspective view of a right side border element, for the signage assembly illustrated in FIG. 1.

FIG. 5 is a perspective view of a left side border element, for the signage assembly illustrated in FIG. 1.

FIG. 6 is a perspective view of a spacer element, for the signage assembly illustrated in FIG. 1.

FIG. 7 is a perspective view of an alpha-numeric block element displaying a letter, which can be used to form the signage assembly illustrated in FIG. 1.

### DETAILED DESCRIPTION OF THE PREFERRED EMBODIMENT

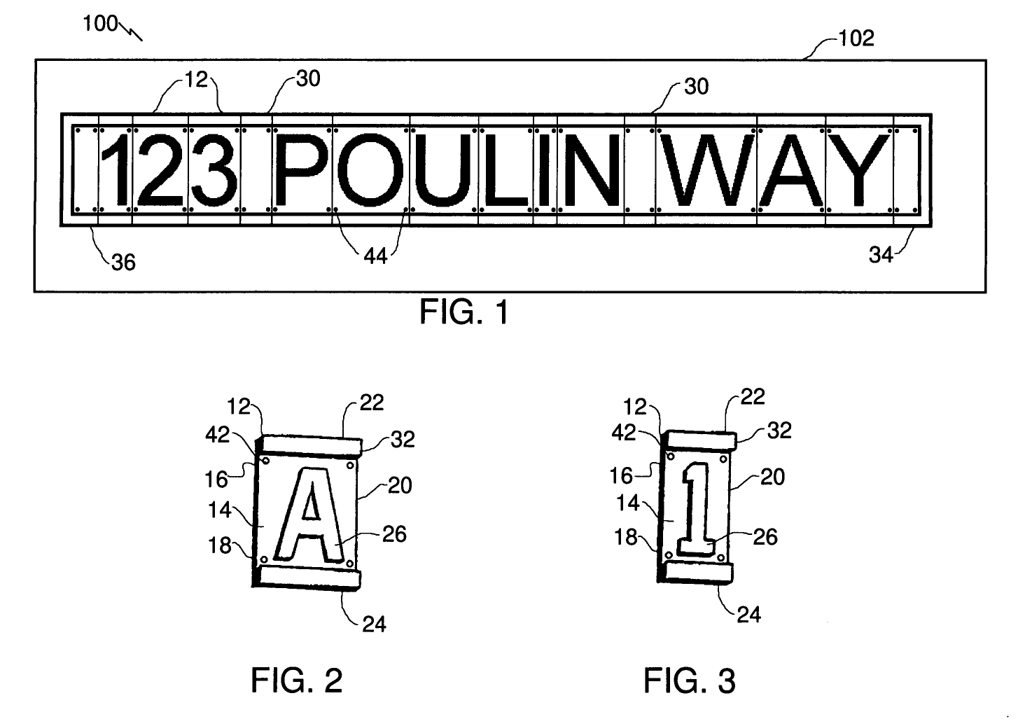

The preferred method will now be described with reference to FIGS. 1 through 6.

Structure and Relationship of Parts:

There will first be described the various elements that are used with the method. Referring to FIGS. 2 and 3, there is illustrated an alpha-numeric tile element 12. Tile element 12 has a display face 14, a mounting face 16 which is opposed to display face 14, a left edge 18, a right edge 20, a top edge 22 and a bottom edge 24. A single alpha-numeric character 26 is displayed on the display face. Alpha-numeric character 26 is a letter in FIG. 2, and a number in FIG. 3. In the illustrated embodiments, alpha-numeric character 26 is raised from display face 14.

Referring to FIG. 7, an alternative embodiment in the form of an alpha-numeric block element 28 is illustrated. As with alpha-numeric tile element 12, alpha-numeric block element 28 has a display face 14, a mounting face 16, a left edge 18, a right edge 20, a top edge 22 and a bottom edge 24. A single alpha-numeric character 26 is displayed on the display face. In the illustrated embodiment, alpha-numeric character 26 shown as being recessed into display face 14.

In the description of the method, which follows, it will be understood that one could use either all alpha-numeric tile elements 12 or alpha-numeric block elements 28. It will also be understood that in order for alpha-numeric character 26 to be visible, it can be either raised from display face 14 or recessed into display face 14.

Referring to FIG. 6, there is illustrated a spacer element 30. Spacer element 30 also has a display face 14, a mounting face 16, a left edge 18, a right edge 20, a top edge 22 and a bottom edge 24. However, display face 14 does not have an alpha-numeric character. Display face 14 of spacer element 30 will normally be blank, although it could bear an ornamental or a space holding symbol, such as a dot or a dash. As will hereinafter be understood from the description of the method, which follows, spacer element 30 serves an important function of separating alpha-numeric characters 26 into number and word groupings. As such, spacer elements 30 are necessary in order to allow alpha-numeric tile elements 12 and alpha-numeric block elements 28 to function properly as signage. In some applications, graphic symbols may be use alone. In most applications, the graphic symbols such as “$”, “%” are universal symbols which, along with the alpha-numeric characters, convey a message.

Referring to FIGS. 2, 3, and 7, it is preferred that a raised border 32 be is provided on display face 14 of each of alpha-numeric tile element 12, alpha-numeric block element 28 and spacer element 30 along top edge 22 and along bottom edge 24. Raised border 32 plays an aesthetic role in connecting the letters and gives continuity to the signage, making it look more professional. It also plays a functional role in protecting alpha-numeric characters 26 on the signage from water running down a face of a building or from blowing snow.

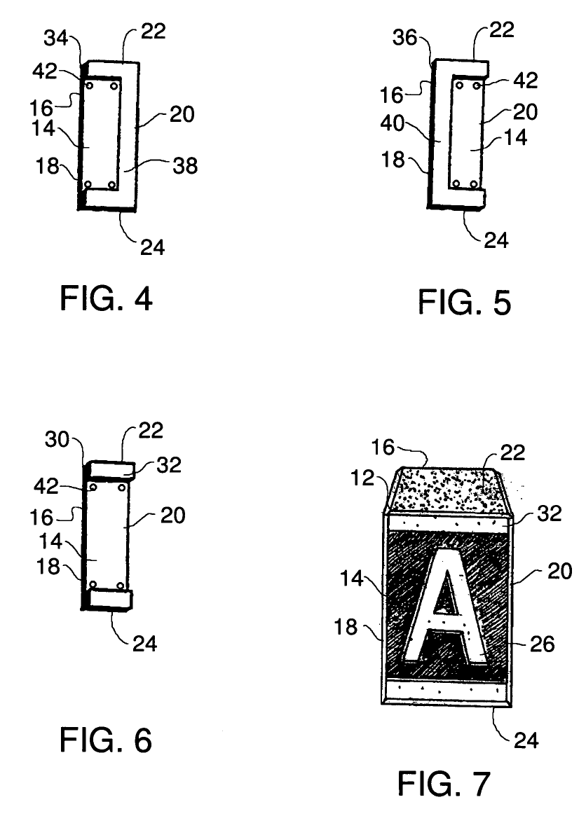

Referring to FIG. 4 and FIG. 5, it is also preferred that a right side border element 34 be provided as illustrated in FIG. 4 and a left side border element 36 be provided as illustrated in FIG. 5. The inclusion of right side border element 34 and left side border element 36 serves to complete the signage assembly and provides a functional role in protecting alpha-numeric characters 26. As with all other elements that have been described both right side border element 34 and left side border element 36 have a display face 14, a mounting face 16, a left edge 18, a right edge 20, a top edge 22 and a bottom edge 24. Right side border element 34 has a raised border 38 on display face 14 along right edge 20. Left side border element 36 has a raised border 40 on display face 14 along left edge 18.

There are, of course, numerous ways in which alpha-number tile elements 12 and alpha-numeric block elements 28 may be mounted. Tile elements 12 could be mounted using adhesive. Block elements 28 could be stacked. However, it is believed that the form of mounting, which has the most universal application, is through fasteners. Referring to FIG. 2 through FIG. 6, apertures 42 are provided through each of the elements from display face 14 to mounting face 16. Apertures 42 are adapted to receive mounting fasteners, identified in FIG. 1 by reference numeral 44.

The initial proto-types of alpha-numeric tile elements 12 were made out of recycled rubber. The initial proto-types of alpha-numeric block elements 28 were moulded out of concrete. It will be appreciated, however, that a variety of materials can be used including rubber, plastic, wood, glass, concrete, composites, or metal.

Operation:

Referring to FIG. 1, there will now be described how a signage assembly generally identified by reference numeral 100 can be made from the various elements described above in accordance with the teachings of the present invention. A first step involves providing an inventory of discrete alpha-numeric elements such as alpha-numeric tile elements 12 illustrated in FIGS. 2 and 3 or alpha-numeric block elements 28 as illustrated in FIG. 7. In addition, spacer elements 30 must be provided as illustrated in FIG. 6. It is envisaged that retail stores will maintain inventories, which include alpha-numeric elements displaying all 26 letters and numbers 0 through 9. A second step involves consumers, who may be members of the public or signage professionals, selecting from the inventory those alpha-numeric elements (alpha-numeric tile elements 12 or alpha-numeric block elements 28) necessary to display a desired alpha-numeric message. They will also have to purchase such spacer elements 30 as may be required to hold places between alpha-numeric elements in order to form word or number grouping in the alpha-numeric message. The alpha-numeric message chosen for illustration in FIG. 1 is an address: 123 POULIN WAY. In order to make sense, this alpha-numeric message must be divided into three groupings: “123”; “POULIN”; and “WAY”. A third step involves the consumer mounting the selected alpha-numeric elements and spacer elements in a desired order to display the desired alpha-numeric message. The preferred manner of mounting being through the use of mounting fasteners 44 inserted into apertures 42 and fastened onto a backing substrate 102.

As described above, it is preferred for both aesthetic and functional reasons that a raised border 32 be is provided on display face 14 of each of alpha-numeric tile element 12, alpha-numeric block element 28 and spacer element 30 along top edge 22 and along bottom edge 24. It is also preferred, for both aesthetic and functional reasons, that a right side border element 34 and a left side border element 36 be provided.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method comprising the steps of:
providing an inventory of discrete alpha-numeric elements and spacer elements, each of the alpha-numeric elements displaying a single alpha-numeric character, the inventory including alpha-numeric elements displaying all 26 letters and numbers 0 through 9;
selecting from the inventory alpha-numeric elements necessary to display a desired alpha-numeric message, together with such spacer elements as may be required to hold places between alpha-numeric elements in order to form word or number grouping in the alpha-numeric message;
arranging the selected alpha-numeric elements and spacer elements in a desired order to display the desired alpha-numeric message.

2. The method as defined in claim 1, the inventory including graphic elements.

3. The method as defined in claim 1, each of the alpha-numeric elements and spacer elements being in the form of one of a block or tile having a display face, a mounting face, a left edge, a right edge, a top edge and a bottom edge.

4. The method as defined in claim 3, each block or tile having a raised border on the display face along the top edge and along the bottom edge.

5. The method as defined in claim 4, a right side border block or tile being provided with a raised border on the display face along the right edge and a left side border block or tile being provided with a raised border on the display face along the left edge.

6. The method as defined in claim 3, apertures being provided through each block or tile from the display face to the mounting face, the apertures being adapted to receive mounting fasteners.

7. The method as defined in claim 3, wherein the alpha-numeric characters are raised from the display face.

8. The method as defined in claim 3, wherein the alpha-numeric characters are recessed into the display face.

9. A product, comprising:
one of a block or a tile having a display face, a mounting face, a left edge, a right edge, a top edge and a bottom edge;
a single alpha-numeric character or graphic symbol being displayed on the display face.

10. The product as defined in claim 9, wherein a raised border is provided on the display face along the top edge and along the bottom edge.

11. The product as defined in claim 9, wherein apertures are provided through the block or tile from the display face to the mounting face, the apertures being adapted to receive mounting fasteners.

12. The product as defined in claim 9, wherein the alpha-numeric character is raised from the display face.

13. The product as defined in claim 9, wherein the alpha-numeric character is recessed into the display face.

14. The product as defined in claim 9, wherein each block or tile is made from one of rubber, plastic, wood, glass, concrete, composites, or metal.

15. A signage assembly, comprising:
a plurality of one of blocks or tiles each having a display face, a mounting face, a left edge, a right edge, a top edge, a bottom edge, and a raised border on the display face along the top edge and along the bottom edge;
a single alpha-numeric character being displayed on the display face of some the blocks or tiles, the blocks or tiles being arranged to form word or number groupings in order to display an alpha-numeric message;
some of the blocks or tiles being spacer blocks or spacer tiles, which do not have an alpha-numeric character and serve to hold places between the word or number groupings;
a right side border block or tile being provided with a raised border on the display face along the right edge and a left side border block or tile being provided with a raised border on the display face along the left edge.

16. The signage assembly as defined in claim 15, wherein apertures are provided through each block or tile from the display face to the mounting face, the apertures being adapted to receive mounting fasteners.

17. The signage assembly as defined in claim 15, wherein the alpha-numeric character is raised from the display face.

18. The signage assembly as defined in claim 15, wherein the alpha-numeric character is recessed in the display face.

19. The signage assembly as defined in claim 15, wherein each block or tile is made from one of rubber, plastic, wood, glass, concrete, composites, or metal.
